(19) United States
(12) Patent Application Publication
(10) Pub. No.: US 2020/0264066 A1
(43) Pub. Date: Aug. 20, 2020

(54) Pressure Measurement at a Test Gas Inlet

(71) Applicant: INFICON GmbH, Koeln (DE)

(72) Inventors: Hjalmar Bruhns, Bonn (DE); Ludolf Gerdau, Elsdorf (DE); Norbert Moser, Koeln (DE); Günter Schmitz, Koeln (DE); Daniel Wetzig, Koeln (DE)

(21) Appl. No.: 16/869,165

(22) Filed: May 7, 2020

Related U.S. Application Data
(62) Division of application No. 15/774,752, filed on May 9, 2018.

(30) Foreign Application Priority Data
Nov. 11, 2015 (DE) 10 2015 222 213.6

(51) Int. Cl. G01M 3/20

(52) U.S. Cl. CPC G01M 3/205

(57) ABSTRACT

A device for measuring the pressure at the test gas inlet of a mass-spectrometric leak detector, wherein a mass spectrometer is connected to the inlet of a high vacuum pump, having its outlet connected to the inlet of a pre-vacuum pump, wherein the inlet of the pre-vacuum pump is connected to the test gas inlet, and wherein the inlet of the pre-vacuum pump and at least one intermediate inlet of the high vacuum pump are connected to each other by a connection line comprising a flow throttle.

### CROSS-REFERENCE TO RELATED APPLICATIONS

This application is a division of U.S. patent application Ser. No. 15/774,752, filed May 9, 2018, which is the United States national phase of International Application No. PCT/EP2016/077242 filed Nov. 10, 2016, and claims priority to German Patent Application No. 10 2015 222 213.6 filed Nov. 11, 2015, the disclosures of which are hereby incorporated in their entirety by reference.

### BACKGROUND OF THE INVENTION

### Field of the Invention

The present invention relates to a method and a device for measuring the pressure at a test gas inlet of a mass-spectrometric leak detector.

### Description of Related Art

In mass-spectrometric leak search, the objects to be examined for leak-tightness are tested under vacuum conditions by use of test gas. For operation of the mass spectrometer, a pressure of less than 10⁻⁴ mbar has to be reached.

Generally, in regard to leak-tightness test methods performed with the aid of a vacuum leak detector, a distinction is made between the vacuum method and the overpressure method. In the vacuum method, the test object is evacuated and exposed to a test gas atmosphere. The gas withdrawn from the test object is examined for the presence of test gas. In the overpressure method, the test object is exposed to a test gas at a pressure which is higher than the pressure of the atmosphere surrounding the test object. The atmosphere surrounding the test object will then be examined for the presence of test gas.

In the vacuum method and in the overpressure method, the testing can be either of an integral type or of a localizing type. In integral leak-tightness testing, the test object is placed in a vacuum and respectively pressure chamber, and the gas withdrawn from the test object and respectively from the test chamber will be examined for the presence of test gas. In integral testing, it is examined whether the test object comprises at least one leak and which total leak rate these leaks have.

In a test process of the localizing type, the site of a leak shall be detected. In the localizing vacuum method, the test object which has been evacuated and connected to the mass-spectrometric leak detector will be sprayed from outside with the test gas by use of a spray gun. In the localizing overpressure method, the test object, while pressurized by the test gas, will be subjected to a sniffing examination from the outside with aid of a hand-guided sniffer probe.

In all of the above described methods, use is made of a mass-spectrometric leak detector which comprises a test gas inlet through which the test gas flow under examination will be suctioned and supplied to the mass spectrometer for detection of the test gas partial pressure. Since an examination with the aid of the mass spectrometer is possible only if a vacuum pressure prevails in the mass spectrometer, it is required that, prior to opening the test gas inlet, the total pressure at the inlet is sufficiently lowered. The mass spectrometer is evacuated by a high vacuum pump, in most cases a turbomolecular pump, and by a pre-vacuum pump connected to the outlet of the high vacuum pump. An intermediate gas inlet of the high vacuum pump is connected to the test gas inlet of the leak detection system.

Detection of a gross leak is possible if the pressure at the test gas inlet is below the allowable primary pressure, typically 15 mbar, for the high vacuum pump. Particularly in case of large volumes (test chamber volumes) which have to be evacuated via the vacuum system of the leak detector, e.g. the pre-vacuum pump, it will take a long time until the allowable pre-pressure of the high vacuum pump is fallen short of and the testing can be started.

Therefore, it is generally desirable to be able to perform a leak search already at an inlet pressure of more than 15 mbar. It is known that, for this purpose, a small partial gas flow can be supplied from the inlet area of the leak detector to the verification system. In the INFICON leak testing device of the type UL400, for instance, a partial flow of the gas flow suctioned through the test gas inlet is fed directly to the mass spectrometer. In case of direct gas introduction into the mass spectrometer (main flow method), it is usually necessitated that, with the aid of a liquid-nitrogen cold trap, the influence of the water vapor from the atmosphere onto the measurement signal is reduced or avoided. The flow restrictor for the partial flow admitted directly into the mass spectrometer is designed in such a manner that, by opening a corresponding valve, the partial flow can be supplied to the mass spectrometer starting from a pressure of less than 100 mbar.

In the INFICON leak testing device UL500, it is possible, for early evidence of a leakage signal (gross leak measurement), to connect the test gas inlet via a throttle to the pre-vacuum of the turbomolecular pump at the mass spectrometer. The throttle is a screen via which, already directly after opening the test gas inlet, at a pressure of less than 1000 mbar for pre-evacuation, a small helium portion will advance in counterflow into the verification system (mass spectrometer) via the turbomolecular pump. This arrangement is described e.g. in EP 283543 A1 and EP 0 615 615 B1.

For detection of massive leaks, it is suitable, in the first step, to evaluate the total pressure drop between 1000 and 100 mbar. In the known methods, measurement of the total pressure at the inlet area of the leak detector is performed by use of a pressure sensor according to the Pirani measuring principle. Such sensors are inexpensive and suited for precise measurement of operating pressures between 10⁻³ and 100 mbar. However, the total pressure in the range between 100 mbar and 1000 mbar can only be detected insufficiently.

In the second step, in case that the pressure is decreasing too slowly because of the existence of a massive leak or that, due to the suctional capacity of the forepump and the gas inflow through the massive leak, an equilibrium pressure above 15 mbar is reached, the massive leak shall be localized by spray application of a test gas.

During the pump-off phase, the verification system of the leak detector is switched into a blind state, or the sensitivity of the leak detector is reduced to the effect that a signal can be evidenced only in case of large leaks. In case of particularly large leakages on the test object, the pump-off period may happen to be extended still further, or the required operating pressure for reaching readiness to measure by use of the vacuum system may not be reached at all. In this case, localization of a gross leak by use of the leak detector actually provided for this task will be impossible.

The total pressure at the inlet flange of the test gas inlet cannot be measured in the pressure range between 100 mbar and 1000 mbar when using a typical Pirani pressure sensor. It is to avoided to use a dedicated total pressure sensor for this pressure range.

### SUMMARY OF THE INVENTION

Thus, it is an object of the invention to make it possible, already at a pressure distinctly higher than 15 mbar, to detect a leaky test object by way of an improved measurement of the total pressure at the test gas inlet of a mass-spectrometric leak detector and to localize the leak.

The total pressure measurement according to the invention relates to mass-spectrometric leak detectors wherein the measurement volume of a mass spectrometer is connected to the inlet of a high vacuum pump, e.g. a turbomolecular pump, and the outlet of the high vacuum pump is connected to the inlet of a pre-vacuum pump. The two-stage vacuum pump serves for evacuating the measurement volume of the mass spectrometer. The inlet of the pre-vacuum pump is further connected to the test gas inlet in order to suction the test gas and respectively to evacuate the test chamber or the test object.

According to the invention, the inlet of the pre-vacuum pump is connected, with the aid of a gas-conducting connection line, to at least one intermediate gas inlet of the high vacuum pump. In the connection line, the gas flow is restricted with the aid of a flow throttle. The connection line can branch off e.g. before the pre-vacuum inlet line connecting the test gas inlet to the inlet of the pre-vacuum pump. The connection line can enter a high vacuum inlet line connecting the intermediate gas inlet to the test gas inlet. Advantageously, in this arrangement, a respective valve is provided in each of the pre-vacuum inlet line, the high vacuum inlet line and the vacuum line connecting the two vacuum pumps, said valve serving for opening and closing the respective line separately.

When, with the aid of the pre-vacuum pump, a test chamber connected to the test gas inlet or a test object connected to the test gas inlet is to be evacuated, gas will be sucked from the test gas inlet through the pre-vacuum inlet line. Via the connection line, a partial flow will be branched off from the pre-vacuum connection line and be supplied to the intermediate inlet of the high vacuum pump. Via the intermediate gas inlet, the partial flow will enter into the measurement volume of the mass spectrometer. Alternatively, the partial flow can also be fed directly into the mass spectrometer. There, the partial pressure of the respectively used test gas, e.g. helium, can be determined. On the basis of the test gas partial pressure, the total pressure prevailing at the test gas inlet can be detected. It is assumed herein that the to-be-evacuated test object or the to-be-evacuated test chamber contains air or another gas with a test gas concentration (helium concentration). Thus, the mass spectrometer, e.g. on the basis of the air/helium portion, will supply a proportionate signal so as to measure the total pressure at the inlet flange of the test gas inlet by use of the mass spectrometer via the helium partial pressure.

The connection line is arranged to enter the high vacuum inlet line between the intermediate gas inlet of the high vacuum pump and the test gas inlet. If there is provided a valve for separately opening and closing the high vacuum inlet line, the connection line enters the high vacuum inlet line between the valve and the intermediate gas inlet.

The partial flow supplied to the mass spectrometer via the connection line will be throttled, preferably to a gas throughput of more than 10⁻⁴ mbar·l/s (with a pressure difference across the throttle from 1000 mbar toward 0 mbar). The throttling is performed as closely as possible to the branch-off site of the connection line from the pre-vacuum inlet line. In principle, said branch-off site can be situated at a random site in the pre-vacuum connection between the test gas inlet and the outlet of the pre-vacuum pump, and thus, if use is made a multi-stage pre-vacuum pump, also between the pump stages. Accordingly, the distance of the throttle to the branch-off site of the connection line from the pre-vacuum inlet line is less than the distance to the connection site of the connection line with the high vacuum inlet line. Preferably, the distance to the branch-off site with the pre-vacuum inlet line is about a third and preferably about a quarter of the total length of the connection line. In the ideal case, the branch-off site is situated directly in the gas flow of the pre-vacuum inlet line. Thus, the throttle is arranged as closely as possible to—or even within—the branch-off site so to achieve an optimum flow toward the throttle for a best possible exchange of gas in order to allow for fast reactions. Due to a turbulent flow, the volume area within the connection line between the branch-off site from the pre-vacuum inlet line and the throttle will be well-flushed to a depth which roughly corresponds to the diameter of the conduit.

The throttle can be designed as a screen or a capillary. The ideal selection of length and diameter is to be made according to the known formulae for gas flow through screens and capillaries in dependence on the diameters and, particularly with a capillary diameter of 25 am, can be a length of 5 cm for reaching a gas flow of 5·10⁻⁴ mbar l/s with 1000 mbar toward 0 mbar. When selecting the diameter and the length, care must be taken that, even at a gas pressure of 15 mbar and a correspondingly reduced flow through the throttle and respectively at a lengthened gas exchange time, sufficiently short response times of typically 1 s are obtained in the throttle.

The throttle allows for a precise measurement of the development of the total pressure directly after starting the pump-off process with the aid of the pre-vacuum pump. The volume in the pre-vacuum area of the turbomolecular pump, i.e. at the outlet of turbomolecular pump, is dimensioned in such a manner that the operation for detection of massive leaks with closed valves in the vacuum line between the high vacuum pump and the pre-vacuum pump, in the high vacuum inlet line and in the pre-vacuum inlet line, can be maintained for a sufficient duration of time. The duration for which the operation for detection of massive leaks is possible will depend on the ratio between the flow through the throttle in the connection line and the volume in the pre-vacuum area of the turbomolecular pump. Resulting from this, together with the allowable maximal total pressure at the pre-vacuum side of the high vacuum/turbomolecular pump, the maximum operation period in massive-leak operation will in the least favorable case be

operating period=V·p_{v,max}/Q

Q: flow through throttle
V: volume of pre-vacuum area
p_{v,max}: maximum allowable pre-vacuum pressure

When specifying the volume, consideration must be given to the typical pump-off times for the application because, with decreasing pressure at the test gas inlet, also the gas flow Q through the throttle will become smaller and, thus, the maximum operation period during detection of massive leaks will become longer. To allow the detection of massive leaks to be performed for one hour without interruption, the volume in the pre-vacuum area is preferably larger than 10 cm³ and in the ideal case 20 cm³. In the worst case, i.e. if the leak on the test object is so large that the pre-vacuum pump cannot reduce the pressure, there will result—with V=20 cm³, p_{v,max}=15 mbar and Q=5·10⁻⁴ mbar l/s—a worst expected operation period of 600 s, after which the operation of the massive-leak detection has to be interrupted for less than 10 s in order to pump the pre-vacuum volume of the turbomolecular pump to the final pressure again, whereupon the operation for detection of massive leaks can be resumed again.

The invention, through the permanent throttle connection between the pre-vacuum pump inlet and the intermediate gas inlet of the high vacuum pump, allows for a particularly fast response of the measurement signal, measurement of leakage rates at working pressures of more than 15 mbar, measurement of the total pressure at the test gas inlet (inlet flange) with reproducible characteristic line, and precise measurement of the total pressure at the inlet flange from 1000 mbar without an additional pressure sensor.

### BRIEF DESCRIPTION OF THE DRAWINGS

Exemplary embodiments of the invention will be described in greater detail hereunder with reference to the Figures. The following is shown:

FIG. 1 shows a first exemplary embodiment,

FIG. 2 shows a second exemplary embodiment, and

FIG. 3 shows a third exemplary embodiment.

### DESCRIPTION OF THE INVENTION

Hereunder, there will first be described those features that are common to the various exemplary embodiments. Substantially, these comprise a leak detection system having a mass spectrometer 12, a high vacuum pump 14, a pre-vacuum pump 16 and a test gas inlet 18.

The mass spectrometer 12 is connected, via a gas-conducting measurement line 20, to the inlet 22 of high vacuum pump 14. High vacuum pump 14 is a turbomolecular pump. The outlet 24 of high vacuum pump 14 is connected in a gas-conducting manner to the inlet 26 of pre-vacuum pump 16 via a vacuum line 28. Provided in vacuum line 28 is a valve V2 adapted to be closed separately. Via said two vacuum pumps 14,16, the measurement volume of mass spectrometer 12 is evacuated.

Test gas inlet 18 is connected in a gas-conducting manner to the inlet 26 of pre-vacuum pump 16 via a pre-vacuum inlet line 30 so as to evacuate, by means of pre-vacuum pump 16, a volume (test chamber or test object) connected to test gas inlet 18. Test gas inlet 18 is further connected, via a high vacuum inlet line 32, to the intermediate gas inlet 34 of high vacuum pump 14.

At a branch-off site 36, a gas-conducting connection line 38 branches off from the pre-vacuum inlet line 30 and enters the high vacuum inlet line 32 at an entering site 40. In this manner, the connection line 38 directly and permanently connects the inlet 26 of pre-vacuum pump 16 to the intermediate gas inlet 34 of high vacuum pump 14, without provision of a valve in connection line 38.

As closely as possible to said branch-off site 36, connection line 38 comprises a throttle 42 which, with a pressure difference across the throttle from 1000 mbar toward 0 mbar across the throttle, allows for a gas throughput of more than 10⁻⁴ mbar·l/s, namely about 2·10⁻⁴ mbar·l/s and will prevent a gas throughput higher than the above.

Throttle 42 is designed as a screen or a capillary.

The distance of throttle 42 from branch-off site 36 is about a tenth of the distance between branch-off site 36 and entering site 40, i.e. the length of connection line 38.

Pre-vacuum inlet line 30 comprises, between test-gas inlet 18 and branch-off site 36, a separately closable valve V1. High-vacuum inlet line 32 comprises, between test-gas inlet 18 and entering site 40, a separately closable valve V4.

In operation, during the initially performed rough evacuation of a volume connected to test-gas inlet 18 (test chamber volume or test object volume), valves V2 and V4 are initially in a closed state and valve V1 is in an opened state. Pre-vacuum pump 16 will then perform the evacuation via test-gas inlet 18.

In order to make it possible, during this rough evacuation via test-gas inlet 18, to measure the pressure on test-gas inlet 18 without necessitating an additional pressure sensor, a partial flow will be branched off from pre-vacuum inlet line 30 via connection line 38 and be supplied to mass spectrometer 12 via intermediate gas inlet 34 of high vacuum pump 14. With the aid of throttle 42, the partial gas flow will be throttled sufficiently for its evaluation by mass spectrometer 12. With the aid of mass spectrometer 12, the partial pressure of the test gas contained in the branched-off gas flow will be detected. Typically, helium is used as a test gas, wherein the helium partial pressure is measured. From the helium partial pressure, a conclusion is drawn on the total pressure at the inlet flange of the mass spectrometer.

Mass spectrometer 12 will be evacuated while valve V2 is in an opened state and valves V1 and V4 are in a closed state. As soon as the pressure in mass spectrometer 12 and the pressure measured with pressure measurement device 27 within pre-vacuum volume 29 is sufficiently low for the operation of mass spectrometer 12 (1·10⁻⁴ mbar in 12 and <1 mbar in 28), valve V2 will be closed. Then, valve V1 will be opened at the test gas inlet for evacuating the test object. As soon as the total pressure at test gas inlet 18 falls below a sufficient value of about 15 mbar, valve V2 will be opened so that the mass-spectrometric analysis for leak detection will be started. Upon further decrease of the total pressure to a value below 2 mbar, valve V1 will be closed and valve V4 will be opened with the objective to reach the classical counterflow leak detection operation.

The second exemplary embodiment differs from the first exemplary embodiment by a second intermediate gas inlet 44 of high-vacuum pump 14. Said second intermediate gas inlet 44 is connected to test gas inlet 18 via a gas-conducting line 46 provided with a separately closeable valve V3.

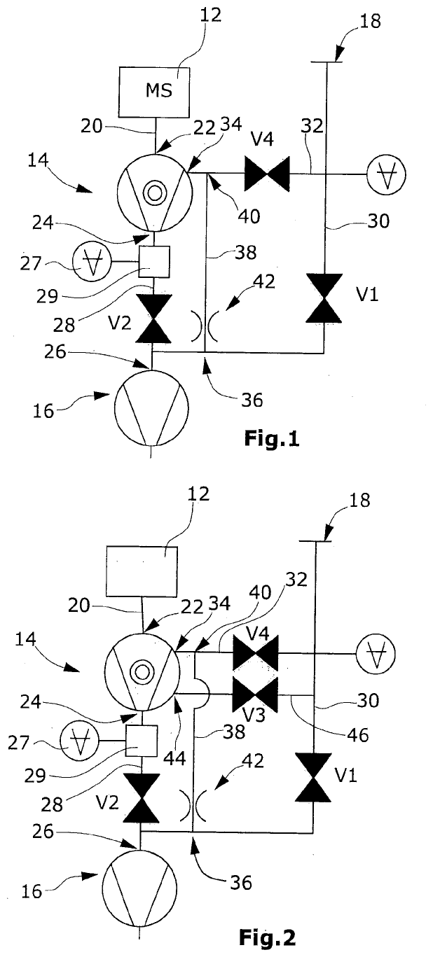

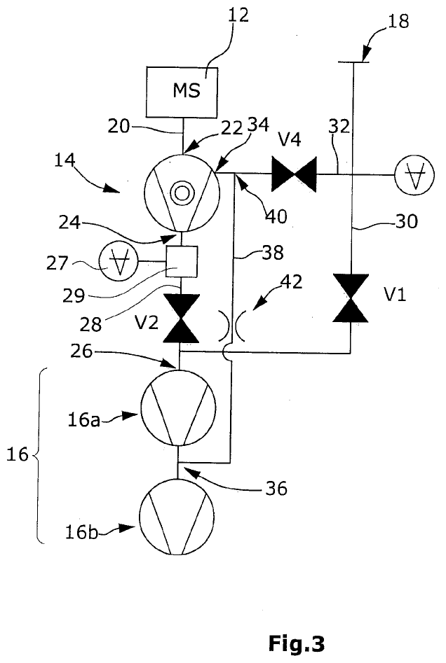

The third exemplary embodiment according to FIG. 3 differs from the exemplary embodiment according to FIG. 1 in that the branch-off point 36 is arranged between the pump stages 16a, 16b of a multi-stage pre-vacuum pump 16. Generally, the branch-off point can be situated at any desired site in the pre-vacuum connection between test gas inlet 18 and outlet 24 of high-vacuum pump 14.

By the pressure measurement as provided according to the invention, it is rendered possible, using a mass-spectrometric leak detector, to measure the pressure at the test gas inlet by mass-spectrometric partial pressure analysis already during still high pressures in the pre-vacuum range during evacuation, without requiring an additional pressure sensor for this purpose.

1. A method for measuring a pressure at a test gas inlet of a mass-spectrometric leak detector, comprising:
connecting a mass spectrometer to an inlet of a high vacuum pump having its outlet connected to an inlet of a pre-vacuum pump via a vacuum line in a gas conducting manner;
connecting the inlet of the pre-vacuum pump to the test gas inlet via a pre-vacuum inlet line in a gas conducting manner, wherein from a gas flow from the test gas inlet to the pre-vacuum pump, a partial flow is branched off, throttled, and supplied to at least one intermediate gas inlet of the high vacuum pump; and
determining the pressure at the test gas inlet by measuring a test gas partial pressure in said branched-off partial flow by means of the mass spectrometer, wherein the vacuum line comprises an additional pre-vacuum volume to which a pressure measurement device is connected.

2. The method according to claim 1, wherein the pre-vacuum volume is dimensioned in such a manner that, when the vacuum line is closed, the pre-vacuum inlet line is closed, and a high vacuum inlet line connecting the test gas inlet and the at least one intermediate gas inlet is closed, operation to detect massive leaks can be maintained for a sufficient duration of time without pumping of the pre-vacuum volume again.

3. The method according to claim 2, wherein the pre-vacuum volume is dimensioned in such a manner that operation to detect massive leaks can be performed for one hour without interruption.

4. The method according to claim 1, wherein the pre-vacuum volume is larger than 10 cm³.

5. The method according to claim 1, wherein the partial flow is throttled to a maximum value in a range of 10⁻⁵ mbar·l/s to 10⁻³ mbar·l/s with a pressure difference of about 1000 mbar.

6. The method according to claim 1, wherein a location of the throttling of the partial flow is arranged closer to the inlet of the pre-vacuum pump than to the at least one intermediate gas inlet of the high vacuum pump.

7. The method according to claim 1, wherein the branched-off partial flow is blocked.
